(19) United States
(12) Patent Application Publication
(10) Pub. No.: US 2009/0259505 A1
(43) Pub. Date: Oct. 15, 2009

(54) Inventory management system and method

(76) Inventor: Vali Tadayon, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/384,892

(22) Filed: Apr. 9, 2009

Related U.S. Application Data
(60) Provisional application No. 61/123,516, filed on Apr. 9, 2008.

(51) Int. Cl. G06Q 10/00; G06F 17/30

(52) U.S. Cl. 705/7; 707/104.1; 705/28; 707/E17.044

(57) ABSTRACT

In one aspect, an inventory management system is provided that includes an input module, a storage module, a completeness module, a notification module and a display module. The input module is adapted to receive a plurality of attributes, where the plurality of attributes related to a plurality of inventory items. The storage module is adapted to store the received plurality of attributes. The completeness module is adapted to determine if each attribute of the plurality of attributes is complete or incomplete. The completeness module is further adapted to determine an attribute completeness value of each attribute of the plurality of attributes. The notification module is adapted to notify a user of the attribute completeness value of each attribute of the plurality of inventory items. The display module is adapted to display the plurality of attributes, the plurality of inventory items and/or the attribute completeness value on a display device.

### CROSS-REFERENCE TO RELATED APPLICATIONS

This application claims the priority of U.S. Provisional Patent Application Ser. No. 61/123,516, filed Apr. 9, 2008 and entitled “INVENTORY MANAGEMENT SYSTEM AND METHOD,” the disclosure of which is incorporated herein by reference.

### FIELD OF THE INVENTION

The present invention relates to inventory management systems and methods. Specifically, the present invention relates to inventory management systems and methods for efficient and accurate display of inventory attributes.

### BACKGROUND

In many industries, a business' inventory is its primary asset. Without proper inventory management, that business may be at a severe disadvantage as compared to competitors and may ultimately fail. Currently, there is not an adequate web-based, comprehensive, easy to use inventory management program available to businesses.

Although many industries rely on product sales as their main source of revenue, the automotive industry is a prime example of such reliance. Without automobile sales, automobile manufacturers would not have the financial resources or drive to continue manufacturing automobiles. Without efficient inventory management, automobile manufacturers and resellers are disadvantaged.

Automobiles are generally a depreciating asset. This means that every day an automobile sits on an automobile dealership's lot and is not sold, the value of that automobile decreases. In turn, this means that the manufacturer and/or reseller of that automobile will likely realize less revenue for that automobile. To maximize revenue, it is in the best interest of the automobile manufacturer and/or reseller to minimize the number of days a specific automobile is located on an automobile dealership's lot. In minimizing the number of days a specific automobile is located on an automobile dealership's lot, organization and management of the automobile inventory is crucial. Such organization and management of inventory may ultimately help maximize revenues and, in turn, maximize profits.

To further help with product sales, the Internet has increasingly become a tool used by consumers to research and evaluate automobiles (or any other product) prior to purchase. With the increased presence and bandwidth of computer networks such as the Internet, more automobile manufacturers and reseller have utilized these networks to advertise, sell or otherwise display their inventory in a digital format. By utilizing the Internet, automobile manufacturers and resellers can now advertise their inventory to virtually anyone in the world.

With the convenient advertising channel that the Internet provides, it is in the best interest of automobile sellers to maximize this exposure by providing potential consumers with as much information about an automobile as possible. A comprehensive, easy to use inventory management program (as described in detail below) fulfills this need.

### SUMMARY OF THE INVENTION

In a first aspect the present invention, an inventory management system is provided that includes an input module, a storage module, a completeness module, a notification module and a display module. The input module is adapted to receive a plurality of attributes, where the plurality of attributes related to a plurality of inventory items. The storage module is adapted to store the received plurality of attributes. The completeness module is adapted to determine if each attribute of the plurality of attributes is complete or incomplete. The completeness module is further adapted to determine an attribute completeness value of each attribute of the plurality of attributes. The notification module is adapted to notify a user of the attribute completeness value of each attribute of the plurality of inventory items. The display module is adapted to display the plurality of attributes, the plurality of inventory items and/or the attribute completeness value on a display device.

In one embodiment of the first aspect, the completeness module determines the attribute completeness value of each attribute of the plurality of attributes based, at least in part, on a prerequisite determined for the plurality of inventory items.

In another embodiment of the first aspect, the notification module includes an icon system relating to the completeness value of each attribute of the plurality of inventory items, and the display module is adapted to display the plurality of attributes, the plurality of inventory items, the attribute completeness value and/or the icon system on a display device. In another embodiment, the icon system includes a first icon indicative of a complete attribute, a second icon indicative of an incomplete attribute and/or a third icon indicative of an attribute that has prerequisites that must be completed. In yet another embodiment, the first icon is displayed in a first color, the second icon is displayed in a second color and the third icon is displayed in a third color.

In even another embodiment of the first aspect, the input module is further adapted to update at least one attribute of the plurality of attributes. In another embodiment, the input module, the storage module, the completeness module, the notification module and the display module are implemented on one or more server systems.

In yet another embodiment, the completeness module is further adapted to determine an item completeness value related to the completeness of the plurality of attributes of an inventory item of the plurality of inventory items. Also, the display module is adapted to display the plurality of attributes, the plurality of inventory items, the attribute completeness value and/or the item completeness value on a display device.

In another embodiment of the first aspect, the completeness module is further adapted to determine an overall completeness value related to the completeness of the plurality of inventory items. Further, the display module is adapted to display the plurality of attributes, the plurality of inventory items, the attribute completeness value, the item completeness value and/or the overall completeness value on a display device.

In even another embodiment, the plurality of inventory items includes automobiles, boating vessels and/or aircraft. In another embodiment, the plurality of attributes include days located at a location, a mileage, hours in use, a price, a transmission type, a warranty, a color, an inspection, a description, pictures, a window sticker and/or a buyer's guide.

In another embodiment of the first aspect, the inventory management system also includes a user management module adapted to create and manage a user account associated with the user. The user management module is also adapted to assign one or more roles to the user account, where each of the roles are associated with predetermined user rights. In another embodiment, the roles include an administrator, a general manager, an internet manager, a sales manager, a sales associate, a photographer and/or a maintenance worker.

In another embodiment, the user may add new inventory items to the plurality of inventory items, add new attributes to the plurality of attributes, update attributes of the plurality of attributes, delete attributes of the plurality of attributes and delete inventory items from the plurality of inventory items.

In another embodiment of the first aspect, the inventory management system also includes a reporting module adapted to generate a report based, at least in part, on an attribute of the plurality of attributes. In one embodiment, the report includes the attribute completeness value, the item completeness value and/or the overall completeness value. In another embodiment, the report includes a graph representative of the attribute completeness value, the item completeness value and/or the overall completeness value. In another embodiment, the report includes a report in a format suitable for display on the Internet.

In yet another embodiment of the first aspect, the inventory management system also includes a pricing module adapted to determine a suggested sales price of the plurality of inventory items based, at least in part, on information obtained from an internal marketing channel, an external marketing channel, a third party, historical sales data and/or customer input. In one embodiment, the suggested sales price is determined, at least in part, by a sales price and a suggested sales price of similar inventory items within a specific geographic area. In another embodiment, the inventory management system also includes an automobile pricing module adapted to determine a suggested sales price of the plurality of inventory items based, at least in part, on information obtained from an internal marketing channel, an external marketing channel, a third party automobile sales source, a third party automobile pricing source, historical automobile sales data and/or customer input.

A second aspect of the present invention provides an inventory management system that includes an inventory item database, a user database, a completeness database, a management component and a display device. The inventory item database is adapted to store a plurality of attributes associated with a plurality of inventory items, where the inventory item database has a plurality of records, each record being associated with one inventory item of the plurality of inventory items. The user database is adapted to store user data associated with a user of the inventory management system, where the user data includes predetermined user rights associated with the user and/or one or more roles associated with the user. The completeness database is adapted to store completeness data relating to a particular attribute of the plurality of attributes, all attributes of the plurality of attributes, a particular inventory item of the plurality of inventory items and/or all inventory items of the plurality of inventory items. The management component is operably coupled to the inventory item database, the user database and/or the completeness database. The management component is adapted to manage the plurality of attributes, the plurality of inventory items, the user data and/or the completeness data. The display device is operably coupled to the management component. The display device is adapted to display the plurality of attributes, the plurality of inventory items, the user data and/or the completeness data.

In one embodiment of the second aspect, the inventory management system further includes a notification component adapted to notify the user of the completeness of a particular attribute of the plurality of attributes, all attributes of the plurality of attributes, a particular inventory item of the plurality of inventory items and/or all inventory items of the plurality of inventory items based, at least in part, on the completeness data.

In another embodiment, the inventory item database, the user database and/or the completeness database is at least partially organized in a virtual file system. In yet another embodiment, the virtual file system includes a network-based active virtual file system adapted to create a repository of an electronic file, an attribute of the plurality of attributes and/or an inventory item of the plurality of inventory items.

In another embodiment, the plurality of inventory items includes a plurality of automobiles. Further, the plurality of attributes include days located at a location, a mileage, hours in use, a price, a transmission type, a warranty, a color, an inspection, a description, pictures, a progress indication, a window sticker and/or a buyer's guide.

In a third aspect of the present invention, an inventory management system includes a computer-readable medium configured to perform a method of managing an inventory. The memory device is configured to perform the steps of: storing, in an inventory item database, a plurality of attributes associated with a plurality of inventory items, where the inventory item database has a plurality of records, where each record of the plurality of records associated with one inventory item of the plurality of inventory items; storing, in a user database, user data associated with a user of the inventory management system, where the user data includes predetermined user rights associated with the user and/or one or more roles associated with the user; analyzing an attribute of the plurality of attributes to determine if the attribute of the plurality of attributes is complete or incomplete, and to determine an attribute completeness value of the attribute of the plurality of attributes; storing, in a completeness database, the completeness value; generating a visual depiction of completeness of the attribute of the plurality of attributes based, at least in part, on the completeness value; and displaying on a display device the plurality of attributes, the plurality of inventory items, the user data, the completeness value and/or the visual depiction of completeness.

In one embodiment of the third aspect, the computer-readable medium is further configured to perform the step of: generating a report based, at least in part, on the attribute of the plurality of attributes. In this embodiment, the displaying step also includes displaying the report on a display device.

In a fourth aspect of the present invention, an automobile inventory management system is provided. This automobile inventory management system includes an inventory build module and a marketing channel module. The inventory build module is operably connected to an inventory item database, a user database and a completeness database. The inventory item database includes a plurality of inventory records associated with a plurality of automobiles, where the plurality of inventory records having a plurality of attributes associated therewith. The user database includes user data associated with a plurality of users. The completeness database includes completeness data associated with completeness of the inventory records.

In this aspect, the inventory build module includes instructions programmed thereon to perform at least one of: displaying the plurality of inventory records on a display device, displaying, on a display device, an icon system relating to the completeness data of each of the plurality of inventory items, where the icon system includes a first icon indicative of a complete attribute, a second icon indicative of an incomplete attribute and/or a third icon indicative of an attribute that has prerequisites that must be completed, sorting the displayed plurality of inventory records based on a particular attribute, filtering the displayed plurality of inventory records based on a particular attribute, adding new inventory records to the plurality of inventory records, deleting inventory records from the plurality of inventory records, editing at least one attribute of the plurality of attributes associated with a particular inventory record, and generating a report based, at least in part, on at least one attribute of the plurality of attributes.

In this aspect, the marketing channel module is operably connected to the inventory item database, the user database and/or the completeness database, and the marketing channel module includes instructions programmed thereon to perform at least one of: displaying the plurality of inventory records on a display device, displaying, on a display device, an icon system relating to the completeness data of each of the plurality of inventory items, where the icon system includes a first icon indicative of a complete attribute, a second icon indicative of an incomplete attribute and/or a third icon indicative of an attribute that has prerequisites that must be completed, sorting the displayed plurality of inventory records based on a particular attribute, filtering the displayed plurality of inventory records based on a particular attribute, determining if an inventory record meets requirements predetermined by marketing channels, transmitting inventory record to the marketing channels, determining a suggested sales price of at least one of the plurality of inventory items based, at least in part, on information obtained from the marketing channels, a third party automobile sales source, a third party automobile pricing source, historical automobile sales data and/or customer input, and generating a report based, at least in part, on at least one attribute of the plurality of attributes.

In one embodiment of the fourth aspect, the plurality of attributes include days an automobile has been located at a location, the number of days the automobile has been entered in the automobile inventory management system, the automobile's stock number, the automobile's mileage, the automobile's price, the automobile's transmission type, the automobile's warranty, the automobile's color, an inspection of the automobile, a description of the automobile, one or more pictures of the automobile, a progress indication, the automobile's window sticker and/or the automobile's buyer's guide.

From the foregoing disclosure and the following detailed description of various preferred embodiments it will be apparent to those skilled in the art that the present invention provides a significant advance in the art of inventory management systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a computer screenshot depicting an exemplary embodiment of the present invention;

FIG. 2 is a computer screenshot depicting an exemplary embodiment of the present invention;

FIG. 3 is a computer screenshot depicting an exemplary embodiment of the present invention;

FIG. 4 is a report associated with an exemplary embodiment of the present invention;

FIG. 5 is a report associated with an exemplary embodiment of the present invention;

FIG. 6 is an automobile window sticker associated with an exemplary embodiment of the present invention;

FIG. 7 is a computer screenshot depicting an exemplary embodiment of the present invention;

FIG. 8 is a computer screenshot depicting an exemplary embodiment of the present invention;

FIG. 9 is a computer screenshot depicting an exemplary embodiment of the present invention;

FIG. 10 is a diagram depicting another exemplary embodiment of the present invention; and

FIG. 11 is a diagram depicting yet another exemplary embodiment of the present invention.

### DETAILED DESCRIPTION

It should be understood that the following detailed description of exemplary embodiments of the invention are exemplary in nature and are not intended to constitute limitations upon the invention. It is also to be understood that variations of the exemplary embodiments contemplated by one of ordinary skill in the art shall concurrently fall within the scope and spirit of the invention. Although certain aspects of the exemplary embodiments are shown in more detail, some features within the purview of one skilled in the art may have been omitted for the sake of clarity and brevity.

It should be further understood that the inventory management system and method discussed herein is not limited to any one industry or product. Although this description primarily focuses on the automobile industry and automobile inventory, the invention may be implemented in virtually any industry or business.

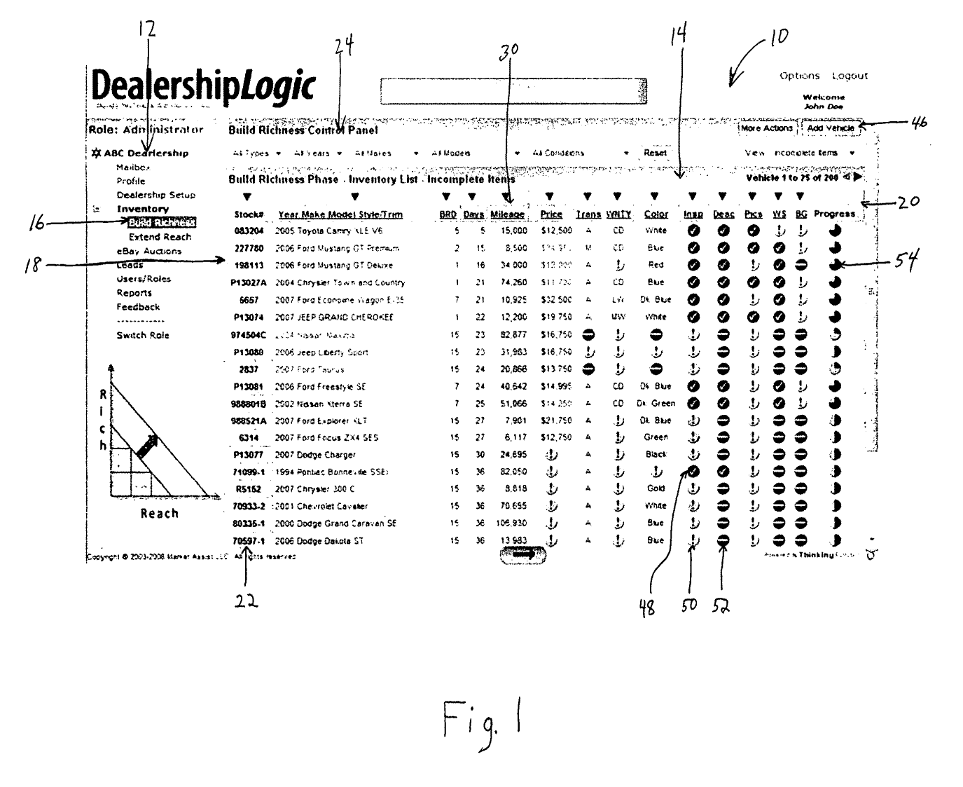

As shown in FIG. 1, a screenshot depicting an exemplary embodiment of the invention is provided. Specifically, a user interface 10 is provided that includes a function panel 12 and a display panel 14. Selecting a function on the function panel 12 causes the display panel 14 to display an interface associated with the selected function. For example, in FIG. 1, a user has selected the Build Richness function 16. Because of this selection, the display panel 14 may display information related to building richness of an inventory.

The Build Richness function 16 in this exemplary embodiment may include the display of inventory records 18. Each inventory record 18 in this embodiment corresponds to one automobile in an automobile dealership's lot. In this embodiment, the inventory records 18 are displayed in a spreadsheet format organized by columns 20 and rows 22. The columns 20 in this example correspond to various attributes associated with a record 18. The rows 22 in this example may represent each individual record 18. More specifically, each row 22 corresponds to an automobile on the automobile dealership's lot.

Near the top of FIG. 1, a Build Richness Control Panel 24 is shown. This Build Richness Control Panel 24 allows a user to filter and/or view inventory items corresponding to selected attributes. For example, a user may wish to view automobiles of a certain type, model year, make, model, and/or condition. This is easily accomplished by utilizing the dropdown boxes located within the Build Richness Control Panel 24. One or more of these dropdown boxes may be used to filter the records 18 that are displayed. Additionally, a user may wish to view only records 18 that are complete, only those that are incomplete, or both complete and incomplete records 18. A user may add a new record 18 to the inventory database by clicking on the “Add Vehicle” button 46. The “Add Vehicle” button 46 displays an input screen where a user may manually enter vehicle information or by automatically retrieving information from a third party source by inputting a vehicle identification number (VIN).

The display panel in this embodiment is arranged by records 18. Specifically, the records 18 are sorted based on the number of days an automobile has been sitting on the automobile dealership's lot. However, the records 18 may be arranged or sorted based on any of the columns 20 (corresponding to specific attributes). The columns 20 correspond to attributes for each record 18. The attributes displayed in this embodiment include Days on the lot, Mileage, Price, Transmission, Warranty, Color, Vehicle Inspection, Vehicle Description, Vehicle Pictures, Window Sticker, Buyer's Guide and Overall Completeness of the record 18. For example, the top record 18 in this embodiment relates to a 2005 Toyota® Camry XLE V6 with stock item #083204. This Toyota® Camry is associated with the following attributes:

| | |
|---|---|
| Days on lot | 5 days |
| Mileage | 15,000 miles |
| Price | $12,500 |
| Transmission | Automatic |
| Warranty | Certified Vehicle Warranty |
| Color | White |
| Vehicle Inspection | Complete and entered |
| Vehicle Description | Complete and entered |
| Vehicle Pictures | Complete and entered |
| Window Sticker | Not yet completed |
| Buyer's Guide | Not yet completed |
| Progress | Less than 100% complete |

This record 18 is less than 100% complete (as shown in the column 20 labeled “Progress”) and, therefore, the automobile is not yet in saleable condition (e.g. the electronically stored automobile information is not yet ready for uploading to Internet-based sales sites, such as the automobile dealership's website, Yahoo! Autos (autos.yahoo.com), eBayMotors (www.ebaymotors.com), Autotrader (www.autotrader.com), or other similar sites).

In an exemplary embodiment, a progress indication attribute may be included in an inventory record. A progress indication attribute may reveal the life cycle of a vehicle at a given point in time, namely from the beginning of the vehicle's inventory record in the system until a particular moment in time. This attribute may reveals the activity of that vehicle. Such an activity log may allow auditing and inspection of tasks performed by each user.

In another exemplary embodiment, a database management system (DMS) attribute may be included in an inventory record. A DMS attribute may allow inventory items to be categorized based on a status of the items. For example, vehicles in transit, vehicles in service or vehicles sold may each have a designated value that may be used to filter and group inventory items based on the DMS attribute. Other attributes may include vehicle trim/style and/or an BRD attribute, which may indicate the number of the days in the Build Richness phase. The BRD attribute may indicate the amount of time that an inventory item has been completed.

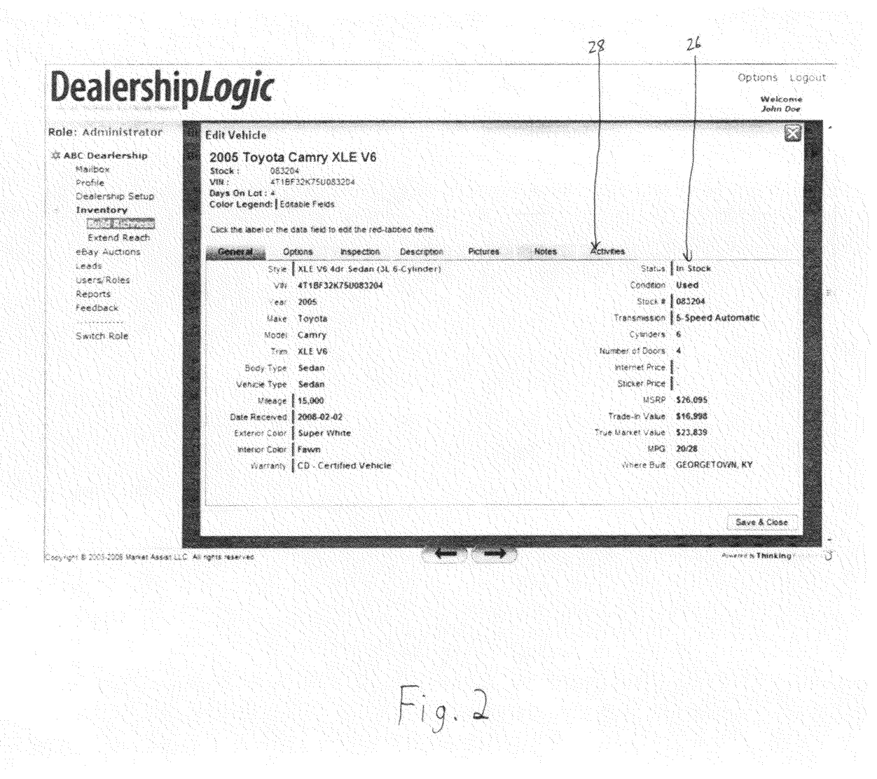

Each attribute may be completed or updated by manually entering information into the inventory database or by automatically retrieving information from a third party source based on a vehicle identification number (VIN). The record 18 associated with the Toyota® Camry (from FIG. 1) may be viewed and edited in the display panel 14 by using a computer input device (such as a mouse) to click or otherwise navigate to the record 18 associated with the Toyota® Camry. FIG. 2 shows an exemplary view of the record 18 associated with the Toyota® Camry. One embodiment also includes a view function (identified by an “eye” icon, for example) that may allow a user to view how the inventory record may be rendered and externalized. This view may include how the inventory item may be displayed on the Internet, for example.

A record 18 associated with a vehicle may have attributes that are completed, not yet completed, or attributes that require a prerequisite task. In FIG. 1, the display panel 14 shows some attributes that are complete. These complete attributes either display the attribute value (such as 15,000 for the mileage attribute) or a green check icon 48. The green check icon 48 indicates successful completion of the required information for the corresponding attribute. The display panel 14 also shows some attributes that are incomplete. These incomplete attributes display a yellow exclamation icon 50. The yellow exclamation icon 50 indicates incomplete required attribute information. The display panel 14 may also show a red “do not enter” icon 52 that signifies that a prerequisite task must be completed prior to completing the attribute. A user may click on or place a mouse cursor on the red “do not enter” icon 52 to view text informing the user what task(s) must be completed prior to completing the attribute. For example, a record that displays a red “do not enter” icon 52 in the description column (the “Desc” column in FIG. 1) may require that the vehicle inspection column (the “Insp” column in FIG. 1) be completed prior to completing the description attribute.

This icon system makes it extremely easy for a user to quickly and visually determine what attributes need to be completed in order to make a vehicle saleable. It should be noted, however, that the icon system discussed above in this example may include any icons, pictures or text and are not limited to the green check icon 48, yellow exclamation icon 50 and red “do not enter” icon 52 discussed above.

Another exemplary feature is the Progress column as shown in FIG. 1. This column 20 corresponds to a representation of overall completeness of a record 18 based, at least in part, on the completeness of each of the required attributes. In this embodiment, the progress column displays a pie chart icon 54. Each pie chart icon 54 may look different based on the completeness of the record 18. For example, a pie chart icon 54 that appears to be three-quarters filled in may mean that the record 18 is approximately 75% complete. Similarly, a pie chart icon 54 that is only one-quarter filled in may mean that the record is only approximately 25% complete. This pie chart icon 54 may give a user a quick representation of how complete a vehicle record 18 is and, in turn, how close the vehicle is to being saleable.

In one embodiment, when an inventory record (or a subset of the inventory record' attributes) is complete, its completeness values may be relative to a marketing channel's requirements. In one embodiment, the completeness value may be determined based on a set of rules based, at least in part, on the requirements of an external and/or internal marketing channel. The rules may be based on the requirements of the marketing channels, as specified during an initial set up of the inventory management system. This aspect allows data to be transmitted to various marketing channels from one system (the inventory management system) without the need to login to different system. In this way, cars.com, eBay, other websites and other marketing channels may each display inventory items based on their specific rules and/or requirements.

The display panel may be sorted by a user to display the records 18 in any manner desired. By clicking on the sort arrow 30 above any column 20, the records 18 may be sorted based on a user's needs. For example, records 18 may be sorted based on any of the attributes including, without limitation, price, year make model, color, progress, etc. This functionality allows a user quick access to records 18 associated with a specific type of vehicle or a specific attribute.

Further, inventory records may be flagged (or identified) for special marketing campaigns. For example, a user may filter the inventory records to identify all vehicles that are 60 days or older with a specific mileage range, color, make, model and those that are designated for a price change. In this way, if a price change occurs, for example, the user may receive a notification of the price change via a messaging system such as Twitter.com, or other messaging media. Further, the price change may be reflected in real-time (or near real-time) on a website or in other marketing channels that are configured to receive such information.

As shown in FIG. 2, attributes associated with a vehicle may be viewed and edited (provided the user has the appropriate access rights). In this embodiment, the attributes are organized by tabs 28, each tab 28 having an associated attribute display area 26. The tabs 28 associated with the Toyota® Camry include a General tab, an Options tab, an Inspection tab, a Description tab, a Pictures tab, a Notes tab and an Activities tab. Upon clicking (or otherwise navigating to a particular tab 28, a user may view various attributes in the attribute display area 26. For example, the General tab may include basic vehicle information such as VIN, body type, condition, price, etc. The Options tab may include options that were offered by the manufacturer (or aftermarket accessories) for the vehicle. The Inspection tab may include comments and/or information related to a vehicle inspection done by an automobile dealership or a third party. This inspection information may include information such as vehicle damage, vehicle accidents, owner history, etc. The Pictures tab may include stock or dealership photographs of the interior, the exterior and/or the engine of the vehicle. The Notes tab may include any information or notes that the dealership wishes to associate with the vehicle. Notes may be for internal restricted use or may be for public viewing. The Activities tab may include any history of the record 18 associated with the vehicle. For example, the Activities tab may include the date and user associated with initially adding the record 18 to the inventory database, any attribute changes in the record 18 and when the record 18 was published to a website. It should be noted that any and all of these attributes may be edited (provided the user has the appropriate access rights) by merely clicking on the attribute and revising the attribute.

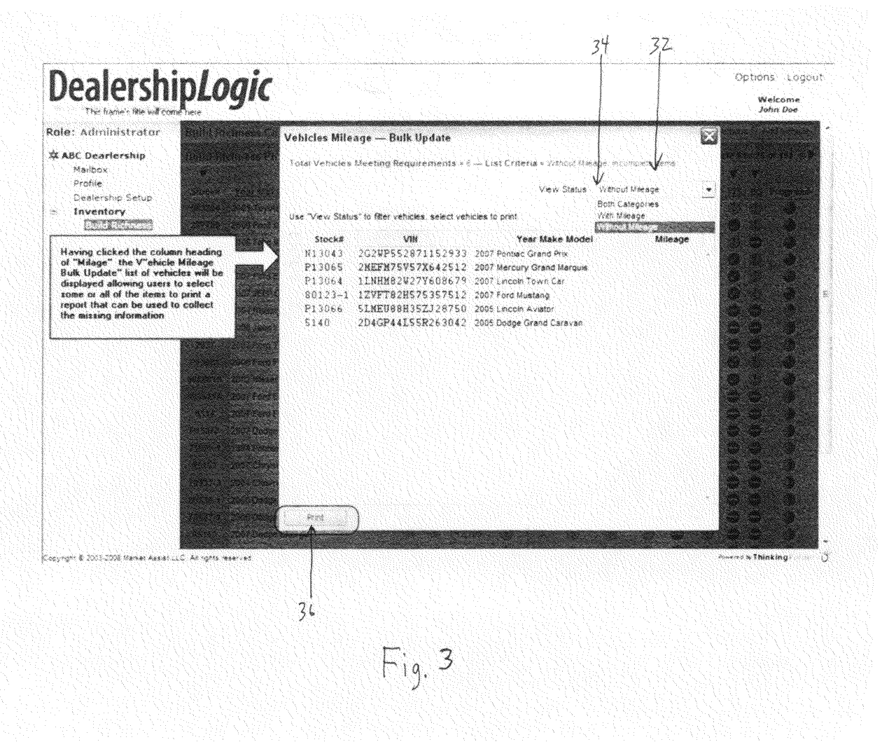

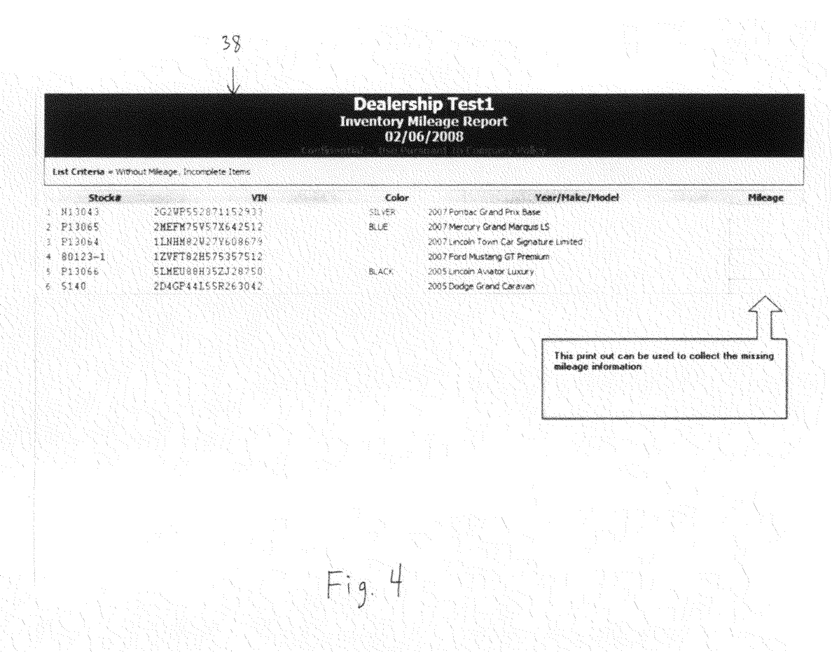

An exemplary feature of one embodiment is the ability of a user to update a plurality of records 18 at the same time. By clicking on a column 20, a user may perform an update of multiple records simultaneously. FIG. 3 depicts a screenshot of a mileage bulk update display 32 that is displayed in the display panel 14. The mileage bulk update display 32 shows all vehicles in a list and the mileage associated with the vehicles. This list may be filtered based on status of the record 18 by utilizing a status dropdown box 34. The status dropdown box 34 may be used to view only those vehicles with a mileage value entered in the record 18, only those vehicles without a mileage value entered in the record 18 or vehicles both with and without mileage values entered in the record 18. FIG. 3 depicts a list of only those vehicles without a mileage value entered in the record 18. This list may then be printed by clicking on the Print command 36. By clicking or otherwise executing the Print command 36, a report of vehicles and their corresponding mileage is generated and may be printed on a printer. FIG. 4 depicts a mileage report 38 of the vehicles displayed in FIG. 3. The mileage report 38 may be useful for users to determine what vehicles in the inventory database do not have completed mileage values. An automobile dealership may use such a report to collect any missing information associated with a record 18. A similar report may be generated for vehicles with a mileage value entered in the record 18, vehicles both with and without mileage values entered in the record 18.

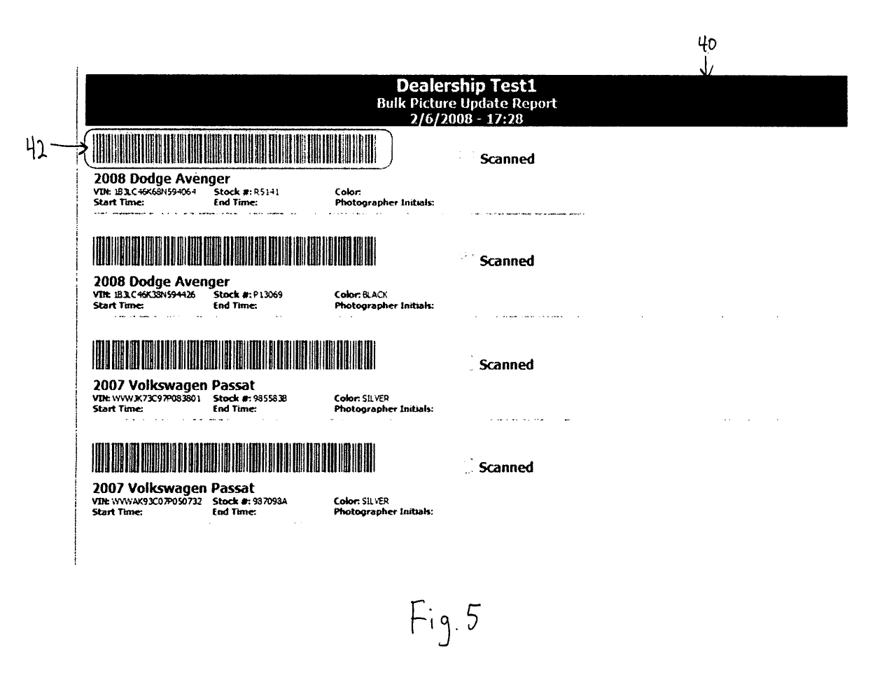

It should be noted that any and all attributes may be updated at the same time. For example, by clicking the column 20 associated with vehicle pictures (i.e. the “Pics” column in FIG. 1), a picture bulk update display may be displayed in the display panel. Similar to the mileage bulk update display 32, a list of vehicles with pictures, without pictures, or vehicles with and without pictures may be displayed. By executing the Print command, a picture update report 40 may be generated and subsequently printed. Shown in FIG. 5, this picture update report 40 may include photographer notes/initials, vehicle information, attributes, and/or a bar code 42 containing vehicle information. This bar code 42 may be useful for a photographer tasked to photograph vehicles that do not have pictures associates with the record 18. Using a specially-equipped camera (such as the Ricoh® Caplio 500 SE-w), a photographer may photograph the bar code 42 associated with the vehicle prior to photographing the vehicle. This specially-equipped camera may be programmed to associate all subsequent photographs with the bar code 42 associated with the vehicle. The camera will continue associating all subsequent photographs with the bar code 42 until the next bar code 42 is photographed. The camera then groups all associated photographs together and transmits the associated photographs to the inventory database to be added to the vehicle's record 18.

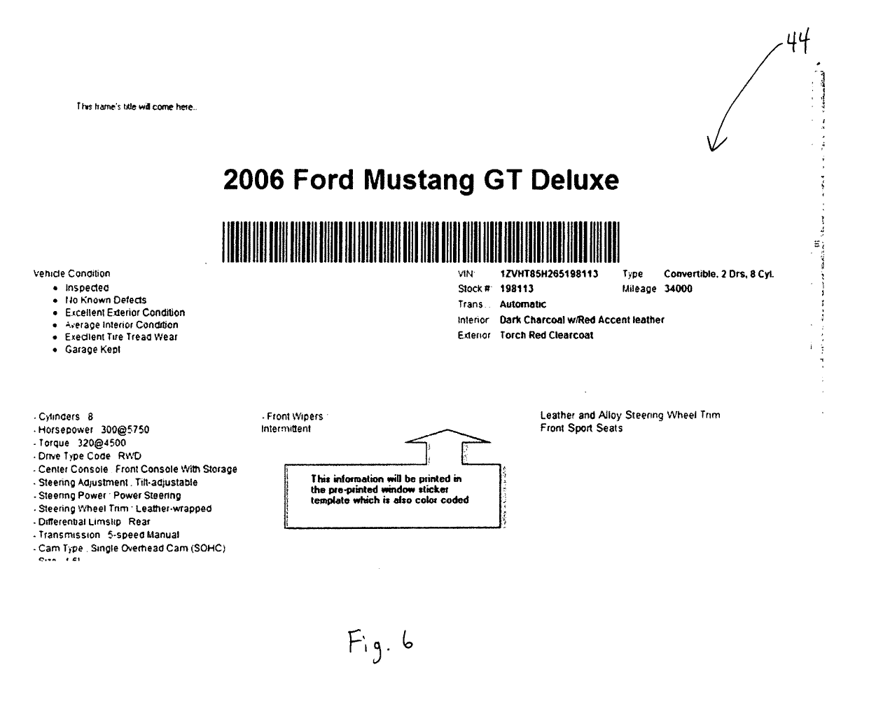

Another report that may be generated using the bulk update feature is a vehicle window sticker 44 as shown in FIG. 6. Window stickers 44 are typically affixed to or displayed in a vehicle window and display certain vehicle information. Window stickers 44 may be required by law in some jurisdictions. However, even if not required by law, window stickers 44 are useful in communicating attributes or information about a vehicle to a consumer. The window stickers 44 generated in this embodiment may be customized to a user's specifications. For example, a user may desire to have a color-coded window sticker 44 system. A green window sticker 44 may signify that the vehicle price is to be marked down 5% for the month of January, while a vehicle with a blue window sticker 44 is to be marked down 10% in January. A window sticker 44 may be customized, generated and subsequently printed for multiple vehicles at the same time by using the bulk update feature.

Although only reports related to mileage, pictures and window stickers 44 are discussed in detail above, the system and method of the invention may generate any type of report related to a vehicle, a record 18 associated with a vehicle or one or more attributes associated with a vehicle. In an exemplary embodiment, generated reports may relate to Days on the lot, Mileage (as shown in FIG. 4), Price, Transmission, Warranty, Color, Vehicle Inspection, Vehicle Description, Vehicle Pictures, Vehicle Picture Update (as shown in FIG. 5), Window Sticker (as shown in FIG. 6), Buyer's Guide and Overall Completeness of the record 18, Vehicle Options, Vehicle Specifications and other attributes or information. Generated reports may be related to a single attribute or may relate to multiple attributes.

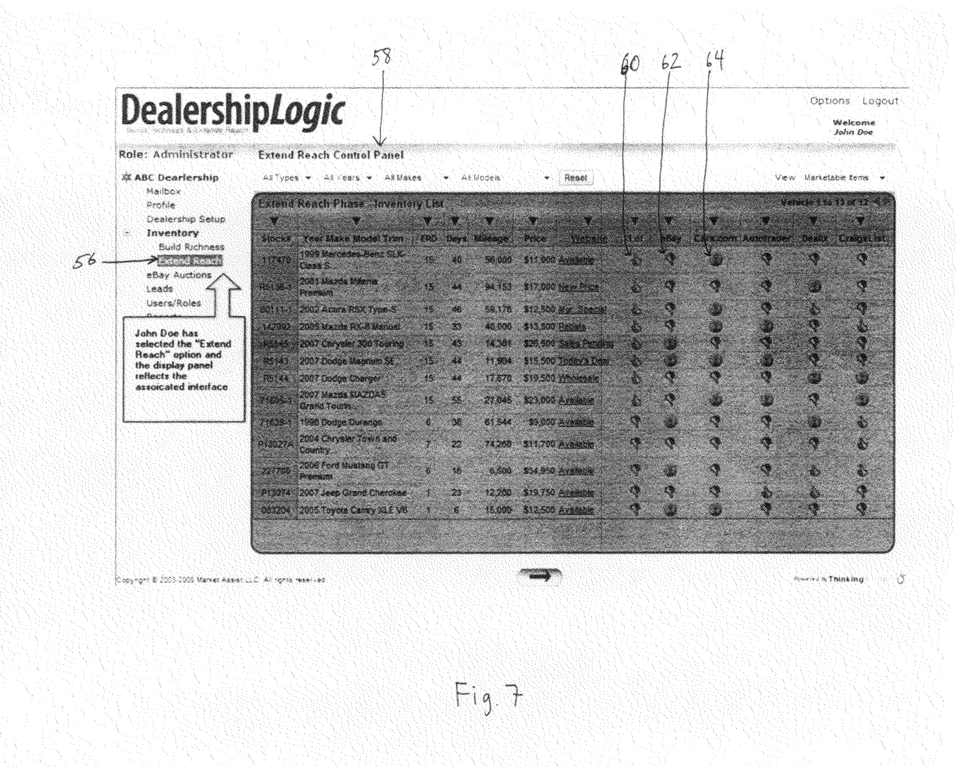

FIG. 7 depicts a screenshot of another aspect of the present invention. When a user clicks on the Extend Reach function 56 in the function panel 12, the display panel 14 displays an interface related to extending the reach of the inventory. Extend Reach functions 56 are related to marketing, pricing and selling inventory items once they are in saleable condition.

The Extend Reach function 56 in this exemplary embodiment also includes the display of inventory records 18. However, this display of records 18 is different from the display related to the Build Richness function 16. The Extend Reach function 56 displays records showing limited attributes. In FIG. 7, the attributes shown include Days on the lot, Mileage and Price. Also shown in this embodiment are Website, Lot, eBay, Cars.com, Autotrader, Dealix and Craigslist columns. The Website and Lot columns relate to internal marketing channels, or marketing channels which the dealership has control over. The eBay, Cars.com, Autotrader, Dealix and Craigslist columns are external marketing channels, or third party marketing channels over which the dealership has limited control, if any.

Near the top of FIG. 7, an Extend Reach Control Panel 58 is shown. This Extend Reach Control Panel 58 allows a user to filter and/or view inventory items corresponding to selected attributes. For example, a user may wish to view automobiles of a certain type, model year, make, model, and/or condition. This is easily accomplished by utilizing the dropdown boxes located within the Extend Reach Control Panel 58. One or more of these dropdown boxes may be used to filter the records 18 to be displayed. Additionally, a user may wish to view only records 18 that are complete, only those that are incomplete, or both complete and incomplete records 18.

One aspect of the Extend Reach function 56 may include a tool to help determine a suggested sales price for an inventory item such as a vehicle. This tool determines a suggested sales price based, at least in part, on information obtained from an internal marketing channel, an external marketing channel, a third party, historical sales data and/or customer input. These sources may further include third party auction websites, third party sales websites and third party valuation websites. Some or all of these information sources may be utilized to ultimately determine a suggested sales price that may reflect similar, recent and/or local vehicle sales. In an exemplary embodiment, the present invention uses an application programming interface (API) to access information from third party websites such as eBay Motors, Google, and Vast.com. Information accessed from these websites may include pricing information, Year, Make, Model and Trim of a vehicle and mileage away from a given zip code. This information may allow a dealership manager to view local pricing and inventory information to price a vehicle appropriately. This exemplary embodiment gathers attributes to enable users to view pricing of comparable vehicles in a specific geographical area. Having vehicle cost, current price, available local inventory of similar vehicles, and other similar information may be a very valuable piece of information to have when pricing a vehicle appropriately.

Similar to the icon system discussed above, the Extend Reach function 56 also utilizes a system to identify vehicles that meet or fail to meet requirements of an internal or external marketing channel. In the embodiment shown in FIG. 7, the Extend Reach function 56 utilizes a green thumbs-up icon 60, a red thumbs-down icon 62 and a yellow hourglass icon 64. The green thumbs-up icon 60 reflects the fact that the vehicle has met the requirements of the corresponding marketing channel. The red thumbs-down icon 62 reflects the fact that the vehicle has not met the requirements of the corresponding marketing channel. The requirements of an internal marketing channel may differ from those of an external marketing channel. The internal marketing channel, for example, may only require that the window sticker 44 and the buyer's guide attributes be completed, whereas an external marketing channel may require that the window sticker 44, buyer's guide and picture attributes be completed. The yellow hourglass icon 64 signifies that the vehicle has met the marketing channel requirements, but is sitting in a queue to the corresponding marketing channel. In some cases, marketing channels may only receive and update their vehicle listings periodically (such as hourly, daily, weekly, etc.). Typically, the uploading and updating process is not in real-time and varies from one channel to the next.

A user with appropriate access may click on the Website column to view and/or edit the status of a vehicle record 18. For example, a dealership may wish to make a certain vehicle a “deal of the day.” To make this vehicle the “deal of the day,” the user merely needs to edit the Website attribute of the vehicle. Upon changing the status of the Website attribute of the vehicle, a dealership website may be automatically updated to reflect the new status. This website update may include showcasing the vehicle on the website's main page, changing the font and/or icon associated with the website listing, and/or any similar update related to the dealership website.

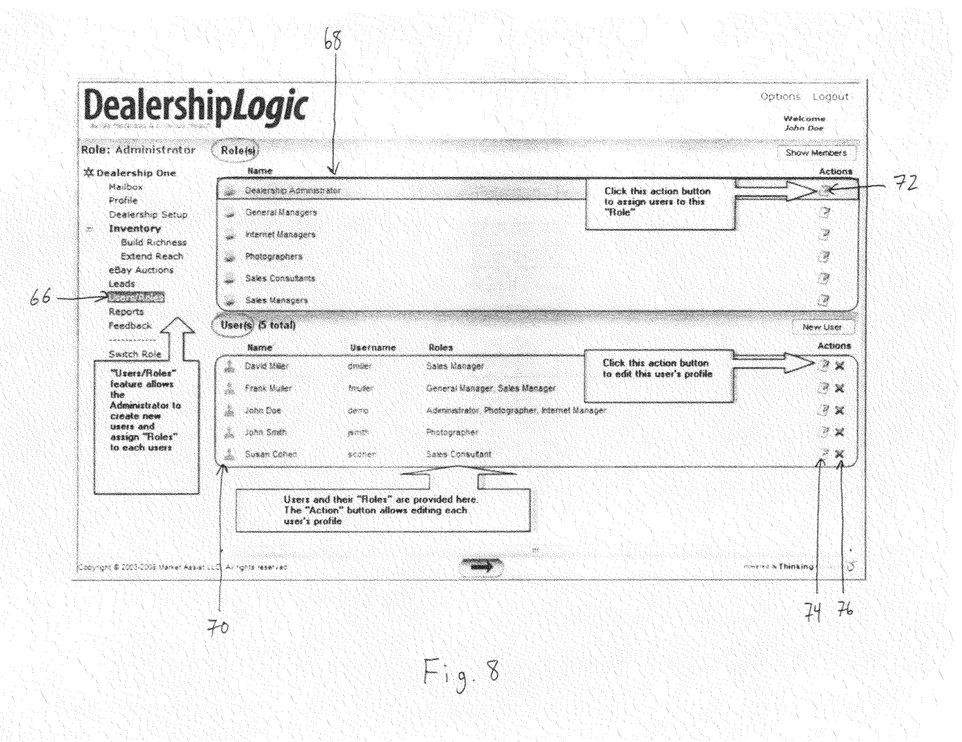

FIG. 8 depicts a screenshot of another aspect of the present invention. When a user clicks on the Users/Roles function 66 in the function panel 12, the display panel 14 displays an interface related to user profiles and roles. The Users/Roles function 66 is related to user access and user rights. The display panel 14 corresponding to the Users/Roles function 66 displays a Roles portion 68 and a Users portion 70. Access to the Users/Roles function 66 is restricted to a limited set of users such as system administrators. System administrators may utilize the Users/Roles function 66 to add, edit or remove users or roles, and/or assign one or more roles to a user. A system administrator may click the Roles action icon 72 to create, edit or delete access rights associated with roles. For example, by clicking the Roles action icon 72 associated with Photographers (as shown in FIG. 8), the rights associated with uploading pictures may be added to the Photographers role. Similarly, a system administrator may click the Users action icon 74 to create or edit user accounts. For example, by clicking the Users action icon 74 associated with Susan Cohen (as shown in FIG. 8), a system administrator may add one or more roles (and the corresponding access rights) such as the General Manager role and Photographers role to the user Susan Cohen. Further, a system administrator may click the Users delete icon 76 to remove a user account. It should be noted that one user may have more than one role assigned to their user account. In this case, a user may have the option to view the user interface 10 associated with one of their multiple roles.

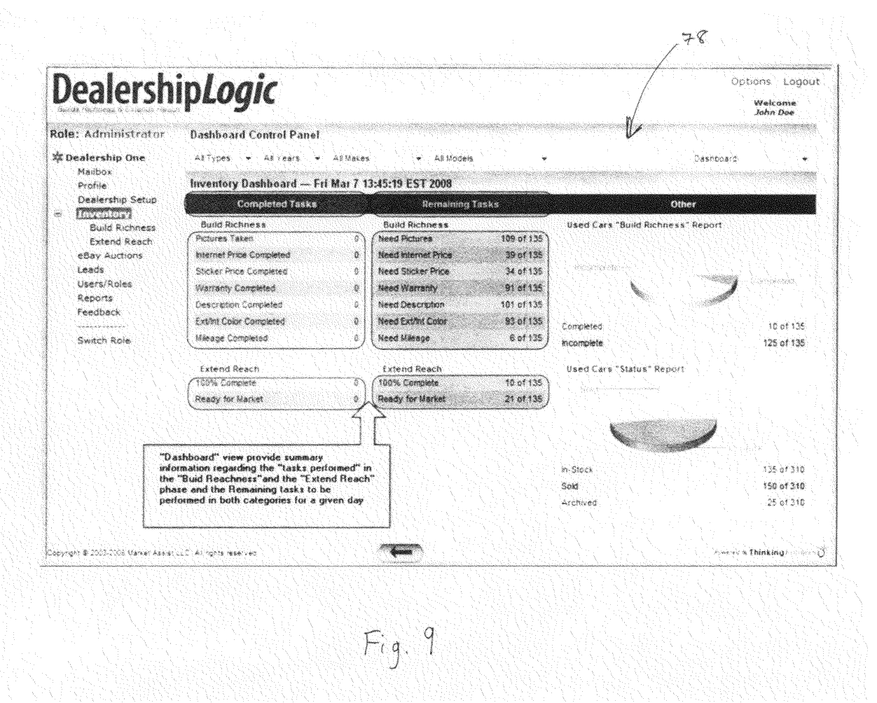

FIG. 9 depicts another aspect of an exemplary embodiment. Specifically, FIG. 9 shows a dashboard view 78, or a high-level view of the overall completeness of the inventory. This view 78 may include summary information regarding the tasks performed (or attributes completed) and the remaining tasks (or the incomplete attributes). Various summaries may be included in this dashboard view 78 including, without limitation, pie charts, percentages, or numeral representations depicting attribute completeness and/or overall completeness. It should be noted that the dashboard view 78 may be further broken down into progress related to the Build Richness function 16 and/or the Extend Reach function 56.

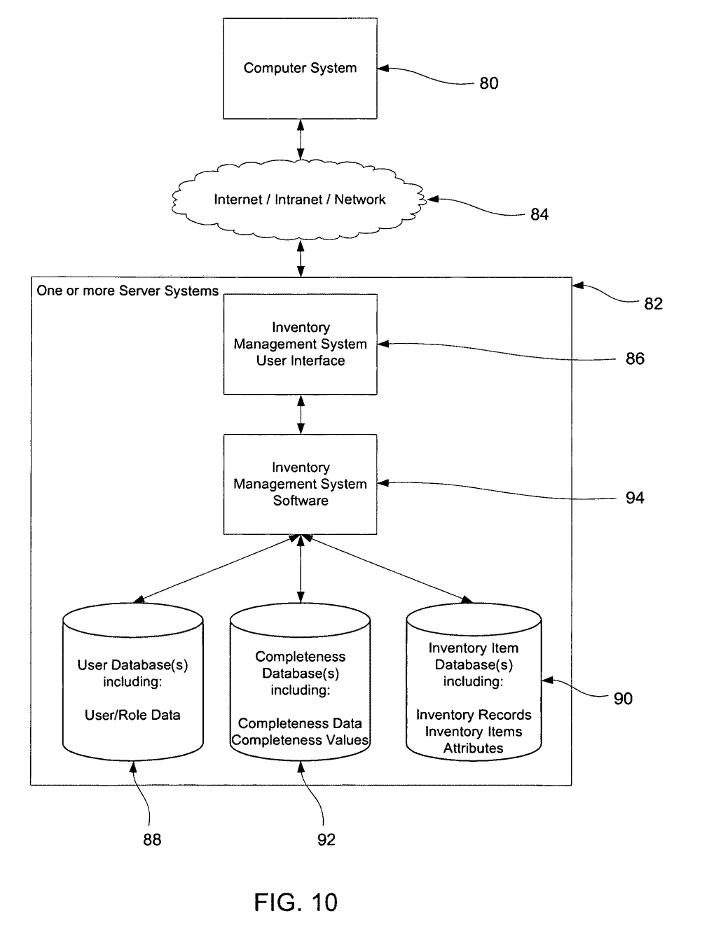

FIG. 10 depicts a diagram showing another exemplary embodiment. This exemplary embodiment shows a computer system 80 operably coupled to one or more servers 82 via a network 84 (such as the Internet, an intranet or other network). The one or more servers 82 may include a user interface 86, one or more user databases 88, one or more inventory item databases 90, one or more completeness databases 92 and a management component 94. The one or more user databases 88 may include user data and roles data, for example. The one or more inventory item databases 90 may include inventory records, inventory items and attributes, for example. The one or more completeness databases 92 may include completeness data and completeness values for example.

In an exemplary embodiment, the inventory management system may implement MySQL and JBoss with EJB3.0—JPA technology. However, other exemplary embodiments may implement other technologies such as Oracle® and/or MS SQL offerings, among others.

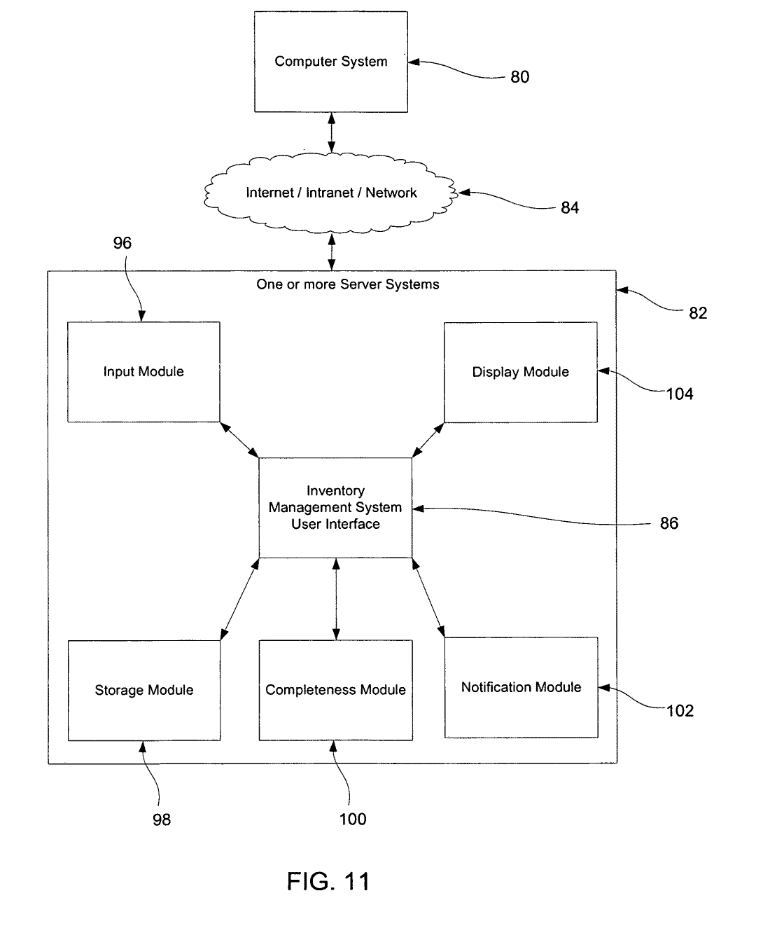

FIG. 11 depicts a diagram showing another exemplary embodiment. This exemplary embodiment shows a computer system 80 operably coupled to one or more servers 82 via a network 84 (such as the Internet, an intranet or other network). The one or more servers 82 may include a user interface 86, an input module 96, a storage module 98, a completeness module 100, a notification module 102 and a display module 104. In embodiment, the input module 96 is adapted to receive a plurality of attributes, where the plurality of attributes are related to a plurality of inventory items. The storage module 98 is adapted to store the received plurality of attributes. The completeness module 100 is adapted to determine if each attribute of the plurality of attributes is complete or incomplete. The completeness module 100 is further adapted to determine an attribute completeness value of each attribute of the plurality of attributes. The notification module 102 is adapted to notify a user of the attribute completeness value of each attribute of the plurality of inventory items. The display module 104 is adapted to display the plurality of attributes, the plurality of inventory items and/or the attribute completeness value on a display device.

The system and method discussed above may be implemented as a web-based service or web-based application. One embodiment may allow network or Internet users to log in to the service or application to view the user interface 10. Such an embodiment may be implemented as an Application Service Provider (ASP). However, other web-based embodiments may be implemented utilizing other scripting or page language techniques.

An exemplary embodiment may be implemented in conjunction with a Web-based Active Virtual File System (WAVFS) similar to that disclosed in U.S. Publication No. US 2004/0249902 to Tadayon et al., the entirety of which is incorporated herein by reference. An exemplary embodiment may utilize the WAVFS to create a repository of any type of files, attributes and/or other objects associated with a vehicle record 18. For example, a vehicle record 18 may include pictures or images, all of these files being stored in the WAVFS, while other attributes such as VIN number, Price, Year, Make, Model and Mileage are stored within the inventory application itself. Since image viewing/editing in one embodiment may be triggered by an event such as a mouse click on the image, this embodiment may easily allow users to keep track of the actions performed on that record 18 within the WAVFS. For example, a user may be able to easily view how many people looked at a particular vehicle on a dealership or third party website. Other objects stored by the WAVFS may include a .PDF format of a vehicle brochure and/or a music and/or video file for use in a vehicle advertisement, among others. This separation may allow the free from data (documents, faxes, emails, websites contents, etc) to participate in the workflow in an elegant way and be part of the transaction and its life cycle. One advantage of utilizing the WAVFS with embodiments of the present invention includes the ability of a user to “roll back the clock” to view a record 18 in various stages of completion. The WAVFS may assist in recording changes to records 18 for future retrieval. Furthermore, the WAVFS may organize users and their associated access rights and security-related user log in issues.

To provide additional context for various aspects of the present invention, the following discussion is intended to provide a brief, general description of a suitable environment in which the various aspects of the invention may be implemented. While one embodiment of the invention has been described above in the general context of computer-executable instructions that may run on one or more computers, those skilled in the art will recognize that the invention also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices. Aspects of the invention may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the invention may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further includes an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

A user may enter commands and information into the computer through one or more wired/wireless input devices, for example, a keyboard and a pointing device, such as a mouse. Other input devices may include a microphone, an IR remote control, a joystick, a game pad, a stylus pen, touch screen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer typically includes other peripheral output devices, such as speakers, printers, etc. A speaker, for example, may be adapted to output an audible signal representative of speech, music or other audio. A printer, for example, may be adapted to print text, graphics, tables, graphs or other representations onto a substrate such as paper, among other substrates.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. An inventory management system, comprising:
an input module adapted to receive a plurality of attributes, the plurality of attributes relating to a plurality of inventory items;
a storage module adapted to store the received plurality of attributes;
a completeness module adapted to determine if each attribute of the plurality of attributes is complete or incomplete, and further adapted to determine an attribute completeness value of each attribute of the plurality of attributes;
a notification module adapted to notify a user of the attribute completeness value of each attribute of the plurality of inventory items; and
a display module adapted to display at least one of the plurality of attributes, the plurality of inventory items and the attribute completeness value on a display device.

2. The inventory management system of claim 1, wherein the completeness module determines the attribute completeness value of each attribute of the plurality of attributes based, at least in part, on a prerequisite determined for the plurality of inventory items.

3. The inventory management system of claim 1,
wherein the notification module includes an icon system relating to the completeness value of each attribute of the plurality of inventory items; and
wherein the display module is adapted to display at least one of the plurality of attributes, the plurality of inventory items, the attribute completeness value and the icon system on a display device.

4. The inventory management system of claim 3, wherein the icon system includes at least a first icon indicative of a complete attribute, a second icon indicative of an incomplete attribute and a third icon indicative of an attribute that has one or more prerequisites that must be completed.

5. The inventory management system of claim 4, wherein the first icon is displayed in a first color, the second icon is displayed in a second color and the third icon is displayed in a third color.

6. The inventory management system of claim 1, wherein the input module is further adapted to update at least one attribute of the plurality of attributes.

7. The inventory management system of claim 1, wherein the input module, the storage module, the completeness module, the notification module and the display module are implemented on one or more server systems.

8. The inventory management system of claim 1,
wherein the completeness module is further adapted to determine an item completeness value related to the completeness of the plurality of attributes of an inventory item of the plurality of inventory items; and
wherein the display module is adapted to display at least one of the plurality of attributes, the plurality of inventory items, the attribute completeness value and the item completeness value on a display device.

9. The inventory management system of claim 1,
wherein the completeness module is further adapted to determine an overall completeness value related to the completeness of the plurality of inventory items; and
wherein the display module is adapted to display at least one of the plurality of attributes, the plurality of inventory items, the attribute completeness value, the item completeness value and the overall completeness value on a display device.

10. The inventory management system of claim 9,
wherein the completeness module is further adapted to determine if the plurality of inventory items satisfy a set of predetermined requirements of a marketing channel.

11. The inventory management system of claim 1, wherein the plurality of inventory items include at least one of automobiles, boating vessels, and aircraft.

12. The inventory management system of claim 1, wherein the plurality of attributes include at least one of days located at a location, a mileage, hours in use, a price, a transmission type, a warranty, a color, an inspection, a description, pictures, a progress indication, a window sticker and a buyer's guide.

13. The inventory management system of claim 1, further comprising:
a user management module adapted to create and manage a user account associated with the user, and further adapted to assign one or more roles to the user account;
wherein each of the one or more roles are associated with predetermined user rights.

14. The inventory management system of claim 13, wherein the one or more roles include at least one of an administrator, a general manager, an internet manager, a sales manager, a sales associate, a photographer and a maintenance worker.

15. The inventory management system of claim 1, wherein the user performs at least one of adding new inventory items to the plurality of inventory items, adding new attributes to the plurality of attributes, updating attributes of the plurality of attributes, deleting attributes of the plurality of attributes and deleting inventory items from the plurality of inventory items.

16. The inventory management system of claim 1, further comprising:
a reporting module adapted to generate at least one report based, at least in part, on at least one attribute of the plurality of attributes.

17. The inventory management system of claim 16, wherein the at least one report includes at least one of the attribute completeness value, the item completeness value and the overall completeness value.

18. The inventory management system of claim 16, wherein the at least one report includes a graph representative of at least one of the attribute completeness value, the item completeness value and the overall completeness value.

19. The inventory management system of claim 16, wherein the at least one report includes a report in a format suitable for display on the Internet.

20. The inventory management system of claim 1, further comprising:
a pricing module adapted to determine a suggested sales price of at least one of the plurality of inventory items based, at least in part, on information obtained from at least one of an internal marketing channel, an external marketing channel, a third party, historical sales data and customer input.

21. The inventory management system of claim 20, wherein the suggested sales price is determined, at least in part, by one or more sales price and one or more suggested sales price of similar inventory items within a specific geographic area.

23. The inventory management system of claim 1, further comprising:
an automobile pricing module adapted to determine a suggested sales price of at least one of the plurality of inventory items based, at least in part, on information obtained from at least one of an internal marketing channel, an external marketing channel, a third party automobile sales source, a third party automobile pricing source, historical automobile sales data and customer input.

24. The inventory management system of claim 1, wherein the notification module is further adapted to notify the user upon a particular attribute being completed

25. An inventory management system, comprising:
an inventory item database adapted to store a plurality of attributes associated with a plurality of inventory items, the inventory item database having a plurality of records, each record of the plurality of records associated with one inventory item of the plurality of inventory items;
a user database adapted to store user data associated with a user of the inventory management system, the user data including at least one of predetermined user rights associated with the user and one or more roles associated with the user;
a completeness database adapted to store completeness data relating to at least one of a particular attribute of the plurality of attributes, all attributes of the plurality of attributes, a particular inventory item of the plurality of inventory items and all inventory items of the plurality of inventory items;
a management component operably coupled to at least one of the inventory item database, the user database and the completeness database, the management component adapted to manage at least one of the plurality of attributes, the plurality of inventory items, the user data and the completeness data;
a display device operably coupled to the management component, the display device adapted to display at least one of the plurality of attributes, the plurality of inventory items, the user data and the completeness data.

26. The inventory management system of claim 25, further comprising:
a notification component adapted to notify the user of the completeness of at least one of a particular attribute of the plurality of attributes, all attributes of the plurality of attributes, a particular inventory item of the plurality of inventory items and all inventory items of the plurality of inventory items based, at least in part, on the completeness data.

27. The inventory management system of claim 25, wherein the at least one of the inventory item database, the user database and the completeness database is at least partially organized in a virtual file system.

28. The inventory management system of claim 27, wherein the virtual file system includes a network-based active virtual file system adapted to create a repository of at least one of an electronic file, an attribute of the plurality of attributes and an inventory item of the plurality of inventory items.

29. The inventory management system of claim 25,
wherein the plurality of inventory items include at least a plurality of automobiles; and
wherein the plurality of attributes include at least one of days located at a location, a mileage, hours in use, a price, a transmission type, a warranty, a color, an inspection, a description, pictures, a window sticker and a buyer's guide.

30. An inventory management system, comprising:
a computer-readable medium configured to perform a method of managing an inventory comprising the steps of:
storing, in an inventory item database, a plurality of attributes associated with a plurality of inventory items, the inventory item database having a plurality of records, each record of the plurality of records associated with one inventory item of the plurality of inventory items;
storing, in a user database, user data associated with a user of the inventory management system, the user data including at least one of predetermined user rights associated with the user and one or more roles associated with the user;
analyzing at least one attribute of the plurality of attributes to determine if the at least one attribute of the plurality of attributes is complete or incomplete, and to determine an attribute completeness value of the at least one attribute of the plurality of attributes;
storing, in a completeness database, the completeness value;
generating a visual depiction of completeness of the at least one attribute of the plurality of attributes based, at least in part, on the completeness value;
displaying on a display device at least one of the plurality of attributes, the plurality of inventory items, the user data, the completeness value and the visual depiction of completeness.

31. The inventory management system of claim 30,
wherein the computer-readable medium is further configured to perform the step of:
generating at least one report based, at least in part, on the at least one attribute of the plurality of attributes;
wherein the displaying step further includes displaying on a display device the at least one report.

32. An automobile inventory management system, comprising:
an inventory build module operably connected to one or more databases having (a) a plurality of inventory records associated with a plurality of automobiles, the plurality of inventory records having a plurality of attributes associated therewith, (b) user data associated with a plurality of users, and (c) completeness data associated with completeness of the inventory records, the inventory build module having instructions programmed thereon to perform:
displaying the plurality of inventory records on a display device;
displaying, on a display device, an icon system relating to the completeness data of each of the plurality of inventory records, wherein the icon system includes at least a first icon indicative of a complete attribute and a second icon indicative of an incomplete attribute;
sorting the displayed plurality of inventory records based on a particular attribute;
filtering the displayed plurality of inventory records based on a particular attribute;
adding one or more new inventory records to the plurality of inventory records;
deleting one or more inventory records from the plurality of inventory records;
editing at least one attribute of the plurality of attributes associated with a particular inventory record; and
generating a report based, at least in part, on at least one attribute of the plurality of attributes; and
a marketing channel module operably connected to the one or more databases, the marketing channel module having instructions programmed thereon to perform:
determining if an inventory record meets one or more requirements predetermined by one or more marketing channels;
transmitting one or more inventory record to the one or more marketing channels; and
determining a suggested sales price of at least one of the plurality of inventory items based, at least in part, on information obtained from at least one of the one or more marketing channel, a third party automobile sales source, a third party automobile pricing source, historical automobile sales data and customer input.

33. The automobile inventory management system of claim 32, wherein the plurality of attributes include at least one of days an automobile has been located at a location, the number of days the automobile has been entered in the automobile inventory management system, the automobile's stock number, the automobile's mileage, the automobile's price, the automobile's transmission type, the automobile's warranty, the automobile's color, an inspection of the automobile, a description of the automobile, one or more pictures of the automobile, a progress indication, the automobile's window sticker and the automobile's buyer's guide.
